(19) United States
(12) Patent Application Publication
(10) Pub. No.: US 2026/0243953 A1
(43) Pub. Date: Aug. 20, 2026

(54) EMBEDDED MICROLENS

(71) Applicant: Applied Materials, Inc., Santa Clara, CA (US)

(72) Inventors: Kenichi OHNO, Santa Clara, CA (US); Steven VERHAVERBEKE, San Francisco, CA (US); Robert Jan VISSER, Menlo Park, CA (US)

(21) Appl. No.: 19/160,739

(22) PCT Filed: Mar. 27, 2024
(86) PCT No.: PCT/US2024/021804

§ 371 Date: Aug. 28, 2025

Related U.S. Application Data
(60) Provisional application No. 63/493,481, filed on Mar. 31, 2023.

(51) Int. Cl. G02B 6/122; G02B 6/12

(52) U.S. Cl. CPC G02B 6/122; G02B 2006/12102; G02B 2006/12104

(57) ABSTRACT

Embodiments described herein relate to a photonic device having a microlens and micromirror embedded therein and methods of fabricating such a device. An example photonic device comprises a substrate; a buried oxide (BOX) layer disposed over the substrate; a waveguide layer disposed over the BOX layer, the waveguide layer comprising a waveguide; a micromirror arranged in at least a portion of the waveguide layer; a cladding disposed over the waveguide layer; and a lens layer disposed over the cladding, the lens layer having a microlens aligned with the micromirror.

### BACKGROUND

### Field

Certain aspects of the present disclosure generally relate to photonic integrated circuits (PICs). More particularly, the present disclosure provides for optical arrangements of PICs.

### Description of the Related Art

With increasing data traffic network demands, networking companies previously using the traditional copper cable for communication have sought out more efficient solutions that could be deployable on a massive scale. Today, optical fiber technologies dominate the long-distance communications space. Networking companies have gradually been transitioning to using optical fibers to transmit data across shorter and shorter distances, even within clusters of devices and device to device or chip to chip. With the use of optical fibers, data is transmitted as photons at the speed of light and can be transmitted at a range of data rates, including at super-high frequencies, thereby allowing for higher data volume transmissions.

### SUMMARY

In one embodiments, a photonic integrated circuit is disclosed. The photonic integrated circuit includes a substrate, a buried oxide (BOX) layer disposed over the substrate, a waveguide layer disposed over the BOX layer, a cladding disposed over the waveguide layer, and a lens layer disposed over the cladding. The waveguide layer includes a waveguide and a micromirror arranged in at least a portion of the waveguide layer. The lens layer includes a microlens aligned with the micromirror.

In another embodiment a photonic integrated circuit is disclosed. The photonic integrated circuit includes a first waveguide, a second waveguide, and an optical via. The optical via includes a first optical redirection element and a second optical redirection element. The first optical redirection element is configured to reflect an optical signal from the first waveguide to the second optical redirection element. The second optical redirection element is configured to reflect the optical signal from the first optical redirection element to the second waveguide.

In yet another embodiment a photonic system is disclosed. The photonic system includes a first photonic integrated circuit (PIC) having a first lens being disposed on a surface of the first PIC and a second PIC having a second lens being disposed on a surface of the second PIC. The first lens is aligned with the second lens such that an optical signal is configured to be communicated between the first lens and the second lens.

In yet another embodiment, a photonic system is disclosed. The photonic system includes a substrate, a buried oxide (BOX) layer disposed over the substrate, a device layer disposed over the BOX layer, a cladding disposed over the device layer, and a lens layer disposed over the cladding. The device layer includes a device. The lens layer includes a microlens aligned with the device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective view of a portion of exemplary co-packaged optical and electrical devices, according to embodiments.

FIG. 2A illustrates an example photonic integrated circuit (PIC) implemented with a microlens array, according to embodiments.

FIG. 2B illustrates a first optical configuration of the PIC, according to embodiments.

FIG. 2C illustrates a second optical configuration of the PIC having a micromirror, according to embodiments.

FIG. 2D illustrates a microlens array, according to embodiments.

FIG. 2E illustrates a fresnel lens, according to embodiments.

FIG. 2F illustrates a flat optic, according to embodiments.

FIG. 3 illustrates a photonic system, according to embodiments.

FIG. 4A illustrates an optical via of the PIC, according to embodiments.

FIG. 4B illustrates the PIC having the optical via, according to embodiments.

FIG. 5 illustrates an example electronic and optical device including the PIC, according to embodiments.

FIG. 6 illustrates a flow diagram of a method of forming a photonic device, according to embodiments.

FIG. 7A-7D illustrates schematic, cross-sectional view of the photonic device during the method of FIG. 6, according to embodiments.

FIG. 8 illustrates a flow diagram of a method 800 of forming a photonic device, according to embodiments.

FIG. 9A-9G illustrates schematic, cross-sectional view of the photonic device during the method of FIG. 8, according to embodiments.

FIG. 10 illustrates a flow diagram of a method of forming a photonic system, according to embodiments.

FIG. 11 illustrates a flow diagram of a method of forming an electronic and optical device including the PIC, according to embodiments.

To facilitate understanding, identical reference numerals have been used, where possible, to designate identical elements that are common to the figures. It is contemplated that elements and features of one embodiment may be beneficially incorporated in other aspects without further recitation.

### DETAILED DESCRIPTION

Certain aspects of the present disclosure generally relate to photonic integrated circuits (PICs). More particularly, the present disclosure provides for optical arrangements of PICs.

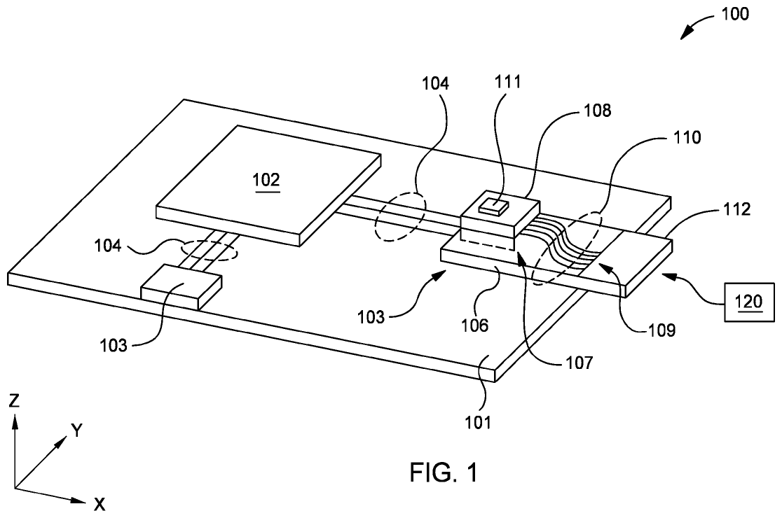

FIG. 1 is a perspective view of a portion of example co-packaged optical and electrical devices 100 comprising an electrical or opto-electrical chip 102 connected by a plurality of optical waveguide or electrical trace interconnect 104 to a photonic integrated interconnect unit 103 where all are formed on or disposed on a package substrate 101. In an aspect, the electrical or opto-electrical chip 102 may include any high-density chip having a high input/output (I/O) pin count. In one example, the high-density chip has between 100 and 2000 I/O pins or up to and greater than 2000 I/O pin counts. Examples of electrical or opto-electrical chips 102 include but not limited to data center SWITCH chips, artificial intelligence (Al) chips, and the like.

The photonic integrated interconnect unit 103 includes a fiber connector region configured to be coupled to a fiber connector 112 for removably connecting a fiber cable 120 to the photonic integrated interconnect unit 103. In an aspect, the fiber cable 120 may be plugged into the fiber connector 112 to operably connect the fiber cable 120 to the co-packaged optical and electrical devices 100. In an aspect, the photonic integrated interconnect unit 103 is configured for connecting fiber cables 120 including, but not limited to, single-mode fiber optic cables having 9 micron fiber core diameters. The fiber connector 112 may further include a plurality of optical fibers to operably connect fiber cables 120 to the photonic integrated interconnect unit 103.

In an aspect, the photonic integrated interconnect unit 103 in the set of co-packaged electrical and optical devices is configured to transmit signals between the electrical or opto-electrical chip 102 and the fiber cable 120 connected to the photonic integrated interconnect unit 103. The photonic integrated interconnect unit 103 includes a photonic glass layer (PGL) substrate 106, a plurality of optical structures 110 formed integral with or on the PGL substrate 106, an optical transceiver integrated circuit (SiPho chip) 108 mounted on the PGL substrate 106 and coupled to the plurality of optical structures 110 at a first interface 107, and the fiber connector 112 connected to both the PGL substrate 106 and the plurality of optical structures 110 at a second interface 109.

In an aspect, the SiPho chip 108 in the photonic integrated interconnect unit 103 operates to convert electrical signals to optical signals, and vice versa. The plurality of optical structures 110 in the photonic integrated interconnect unit 103 operate to transmit optical signals between the SiPho chip 108 and the fiber connector 112, and the optical waveguide or electrical trace interconnect 104 operate to transmit electrical or optical signals between the photonic integrated interconnect unit 103 (specifically, the SiPho chip 108) and the electrical or opto-electrical chip 102. The optical waveguide or electrical trace interconnect 104 can include metal traces that are formed within the package substrate 101, which in some aspects can include metal traces formed in a printed circuit board (PCB) substrate or metal traces formed within a plurality of redistribution layers (e.g., dielectric containing layers) formed over a solid core substrate (e.g., silicon or glass core substrate).

The photonic engine may optionally further include one or more electronic phy chips 111 that are coupled to the SiPho chip 108. The electronic phy chip 111 is generally used to assist with operations performed by an optical chip. In one aspect, the electronic phy chip 111 is operably connected to the SiPho chip 108 to assist the SiPho chip 108 with various electrical functions. As shown, the electronic phy chip 111 may be mounted on top of the SiPho chip 108 and thereby directly connected to the SiPho chip 108. Alternatively, the electronic phy chip 111 may be embedded in the PGL substrate 106 and connected to the SiPho chip 108 through the PGL substrate 106, which is often simply referred to herein as a substrate 106. Further, the electronic phy chip 111 can be mounted on or embedded in the package substrate 101 and connected to the SiPho chip 108 through electrical trace interconnect 104. In some aspects, photonic integrated circuits (PICs), such as the SiPho chip 108, may include microlenses such that an optical signal may be communicated between the PICs using the microlenses, as described in more detail herein.

Electrical microbumps are commonly used as a two-dimensional electrical signal input/output (I/O) interface in computer chips, which allows massive data I/O (e.g., providing density and communication speed). Demand for data I/O density for the photonic ICs (PICs) is increasing but is constrained due to the lack of a way to make photonic I/O that is scalable and alignment tolerant. Moreover, a wide area of a PIC surface may be occupied by the optical circuitry (e.g., optical mode volume convertor and optical fiber attachment), eating up the expensive real estate of the chip surface. Certain aspects of the present disclosure provide techniques for enabling optical I/O ports on a PIC without losing the real estate of the PIC chip area by routing the optical signal from one side to another side of the chip in combination with a dense array of fiber I/O microlenses. Other aspects are directed to techniques for forming a scalable and large alignment-tolerant optical data I/O using microlenses.

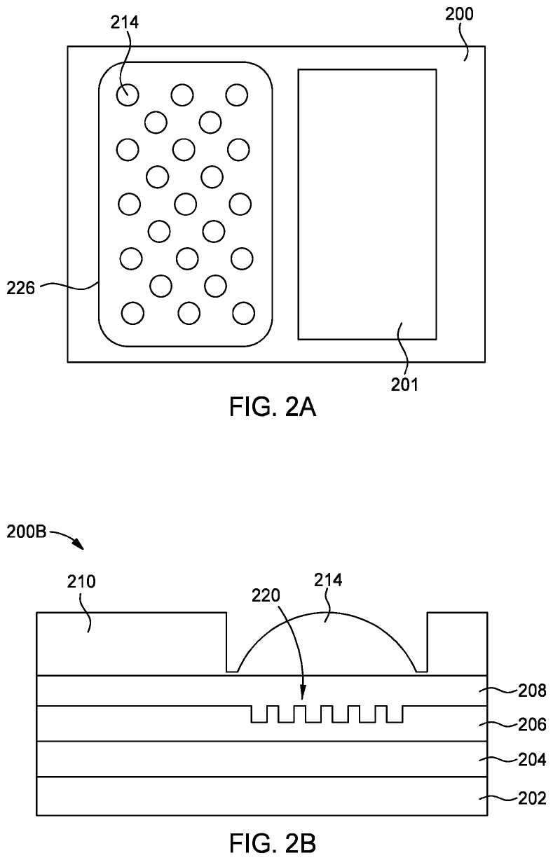

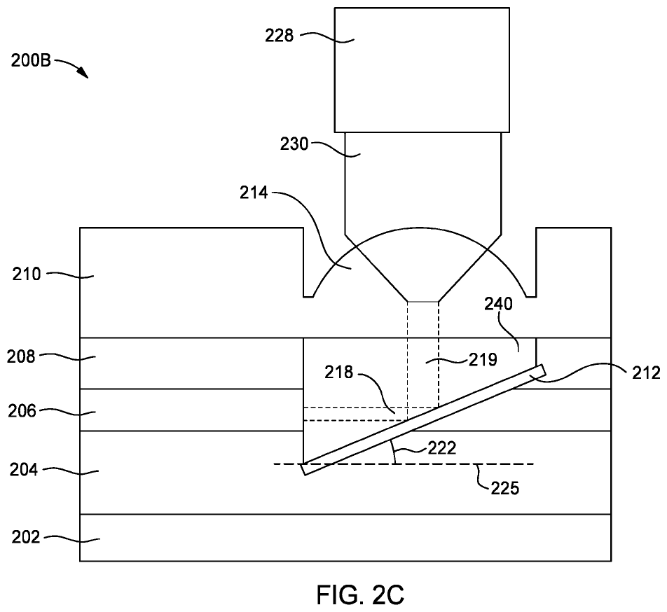

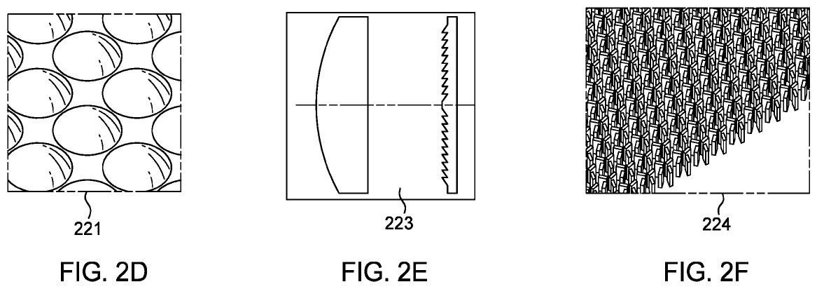

FIG. 2A illustrates an example photonic integrated circuit (PIC) 200 implemented with a microlens array 226. The microlenses and micro-mirrors may be integrated into the PIC as a two-dimensional optical fiber input/output (I/O) array on one side of the PIC 200 (e.g., the back side of the chip). As shown, the microlens array 226 may include microlenses, such as the microlens 214. The microlens 214 may be a microlens array 221 (FIG. 2D), a fresnel lens 223 (FIG. 2E), or a flat optic 224 (FIG. 2F). The flat optic may be a metasurface. The microlens 214 may made from organic liquids. The microlens 214 may be implemented via the optical configuration 200B or the optical configuration 200C (or a combination of the optical configurations 200B, 200C). The PIC may include one or more photonic circuits 201.

FIG. 2B illustrates the optical configuration 200B of the PIC 200. As shown by optical configuration 200B, a buried oxide (BOX) layer 204 may be formed above substrate 202 (e.g., a silicon substrate). A waveguide layer 206 may be formed on the BOX layer 204, which may include a device 220. The device 220 is an optical component with a periodic structure that diffracts light into several beams traveling in different directions (e.g., different diffraction angles). For example, the device 220 may change the direction of propagation of an optical signal from the waveguide layer 206 such that the optical signal propagates to the microlens 214 formed above the device 220. The device 220 is a grating coupling, waveguide, mode-volume converter, a laser, a light emitting diode (LED), VECEL, DNA cell, or on-chip biological device. A lens layer 210 is disposed over the cladding 208. The lens layer 210 includes the microlens 214. The lens layer 210 is an optical dielectric film. The optical dielectric film includes, but is not limited to, aSi, SiO, SiN, TiO, TaO, NbO, AlO, CrO, MgO, or any combination thereof. The lens layer 210 may include the same material as the cladding 208.

A cladding 208 may be formed above the waveguide layer 206, where a microlens 214 may be formed in the cladding 208. The cladding 208 may be disposed over the waveguide layer 206. The cladding 208 may include, for example, amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), or any combination thereof.

FIG. 2C illustrates the optical configuration 200C of the PIC 200 having a micromirror 212. For example, a plurality of photonic assemblies may be integrated into the PIC as a two-dimensional optical fiber input/output (I/O) array. As shown, the optical configuration 200C of the PIC 200 comprises the micromirror 212 and a microlens 214 aligned with the micromirror 212. The micromirror 212 may be disposed adjacent to the waveguide layer 206. The micromirror 212 reflects the optical signal from the waveguide layer 206 towards the microlens 214. In some cases, the optical configuration 200C of the PIC 200 may include a waveguide layer 206 that guides electromagnetic waves in a spectrum (e.g., the optical spectrum). The waveguide layer 206 may be arranged to emit the electromagnetic waves in a radiation path 218 that intersects at least a portion of the micromirror 212. The electromagnetic waves that strike the micromirror 212 may be reflected in a reflection path 219 (e.g., an optical reflection path) that intersects at least a portion of the microlens 214. The radiation pattern of the electromagnetic waves may be adjusted by the microlens 214. For example, the microlens 214 may expand (or focus) the beam of radiation reflected from the micromirror 212 and/or emitted from a photonic device 228.

In certain aspects, the optical configuration 200C of the PIC 200 may include a substrate 202 (e.g., a silicon substrate), a buried oxide (BOX) layer 204, a waveguide layer 206, a cladding 208, and a lens layer 210. The BOX layer 204 may be disposed over the substrate 202. The waveguide layer 206 may be disposed over the BOX layer 204. In some cases, the sidewall of waveguide may be coated for anti-reflection and protection. The cladding 208 may be disposed over the waveguide layer 206. The cladding 208 may include, for example, amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), or any combination thereof. At least one lens layer 210 may be disposed over the cladding 208. The lens layer 210 includes the microlens 214. The lens layer 210 may include an optical dielectric film. The optical dielectric film may include, for example, aSi, SiO, SiN, TiO, TaO, NbO, AlO, CrO, MgO, or any combination thereof. In some cases, the lens layer 210 may include the same material as the cladding 208.

The micromirror 212 may include an optically reflective surface, such as a reflective metal or metal alloy. The micromirror 212 may include, for example, aluminum (Al), silver (Ag), copper (Cu), gold (Au), chromium (Cr), titanium (Ti), or any combination thereof. As an example, the micromirror 212 may be formed by metal deposition on a slanted bottom of an etch, as further described herein. The micromirror 212 may be slanted (sloped or inclined) at a particular angle 222 to facilitate the reflection path 219 intersecting the microlens 214. For example, the micromirror 212 may be slanted at an angle of 0 degrees to 90 degrees relative to a plane 225, which may be parallel with the waveguide layer 206 and/or the lens layer 210. In certain aspects, the sidewall of the etch cavity for the micromirror 212 may be coated with anti-reflection coating. For certain aspects, the micromirror 212 may be coated with a protective coating, such as oxidation protection. The coating may include a dielectric film including, for example, SiO, SiN, TiO, NbO, TaO, AlO, or any combination thereof.

The microlens 214 may include any suitable optical lens including, for example, a microlens array (FIG. 2D), a Fresnel lens (FIG. 2E), a flat optic (FIG. 2F), or any combination thereof. The flat optic may include a metasurface. The Fresnel lens may be nano/micro-machined. For flat optics, multiple layers may be deposited over the cladding 208. For example, the flat optic or metasurface may include an array of nano/micro-structured posts. The microlens 214 may be made from organic liquids. The size of the microlens 214 may be from 100 nanometers (nm) to 1000 micrometers (μm). The microlens 214 may be aligned with the micromirror 212. For example, the microlens 214 may be arranged to be in the reflection path 219 of the micromirror 212. The microlens 214 may be formed via a deposition of one or layers (or films) of the lens layer 210. The lens layer 210 may be deposited via chemical vapor deposition (CVD), a physical vapor deposition (PVD), and/or atomic layer deposition (ALD), for example. The lens layer 210 may have a thickness of 100 nm to 1000 μm as a single layer (or film) or as a stack of multiple layers (or films). The microlens 214 may be formed via patterning, such as photolithography, nanoimprint lithography (NIL), gray-tone lithography, e-beam lithography, etching, focused ion beam milling, ion milling, or a combination thereof

In certain aspects, a gap fill 240 may be disposed between the micromirror 212 and the microlens 214. The gap fill 240 may be disposed over the micromirror 212 to facilitate the formation or disposition of the microlens 214 over the micromirror 212. The gap fill 240 may include any dielectric film, including, for example, silicon oxide (SiOx), silicon nitride (SiNx), titanium oxide (TiOx), or a combination thereof. In certain cases, the gap fill 240 may be removed from the PIC 200, as further described herein.

For certain aspects, a photonic device 228 may be arranged in the radiation pattern 230 associated with the microlens 214. The photonic device 228 may include a silicon photonic device including, for example, a grating coupling, a waveguide, a mode-volume converter, a laser, a light emitting diode (LED), vertical-external-cavity surface-emitting-laser (VECSEL), a microfluidic device, deoxyribonucleic acid (DNA) cell, an on-chip biological device, or a combination thereof.

While the example depicted in FIG. 2C is described herein with respect to the waveguide layer 206 emitting electromagnetic radiation and the micromirror 212 reflecting the radiation to the microlens 214, aspects of the present disclosure may also apply to electromagnetic radiation traveling in the opposite direction. For example, electromagnetic radiation may pass through the microlens 214, which may focus or disperse the radiation. The electromagnetic radiation emitted from the microlens 214 may strike the micromirror 212, which may reflect the electromagnetic radiation to the waveguide layer 206. In such cases, the radiation path 218 may be representative of a reflection path 219, and the reflection path 219 may be representative of a radiation path.

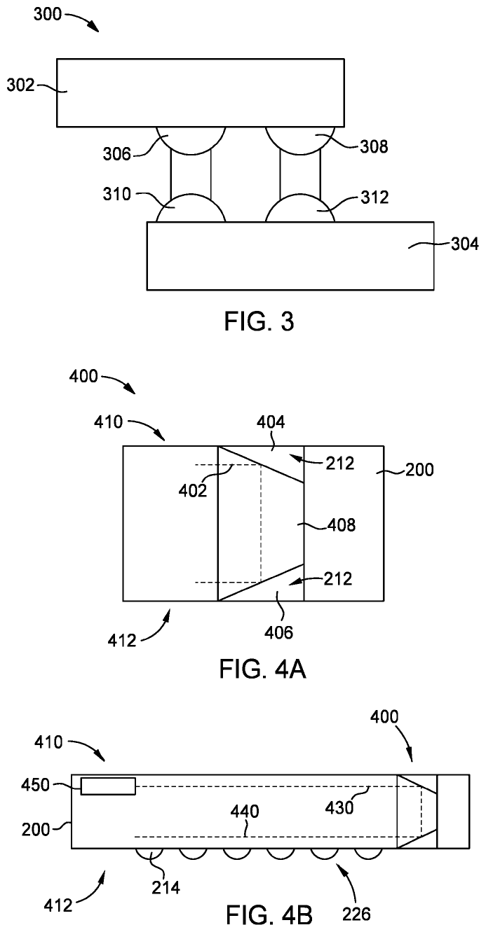

FIG. 3 illustrates a photonic system 300. The photonic system 300 includes a first PIC 302 and a second PIC 304 having aligned microlenses for optical communication. The first PIC 302 may include microlenses 306, 308. The second PIC 304 may include microlenses 310, 312. As shown, a first microlens 306 may be aligned (e.g., on a vertical axis) with a first microlens 310, allowing an optical signal (e.g., optical beam) to propagate between the first microlenses 306, 310, as shown. Similarly, a second microlens 308 may be aligned (e.g., on a vertical axis) with a second microlens 312, allowing an optical signal (e.g., optical beam) to propagate between the second microlenses 308, 312, as shown.

The first PIC 302 may have an array of embedded microlenses (e.g., including first microlens 306 and second microlens 308) on its surface (e.g., a top surface or both top and bottom surfaces). The second PIC 304 may also have an array of embedded microlenses (e.g., first microlens 310 and second microlens 312). The position of the PICS 302, 304 may be arranged so that the microlenses are aligned. The distance between the microlenses (e.g., first microlenses 306, 310) may be anywhere between 1 nm to 10 mm, in some aspects. A signal may be communicated between two PICs through an optical beam that is propogating in and out through microlenses on either/both PICs. The embedded microlens may allow for an in-plane alignment tolerance of up to several 10s of um (e.g., 30 um may be the target).

FIG. 4A illustrates an optical via 400 of a PIC (e.g., PIC 200). FIG. 4B illustrates the PIC (e.g., PIC 200) having the optical via 400. An opening 408 may be formed in the PIC 200. The opening 408 may be a hole through at least a portion of a substrate of the PIC 200 (e.g., a hole from one side of the substrate to another side of the substrate). A first mirror 404 and a second mirror 406 may be disposed in the opening 408. The first mirror 404 and second mirror 406 may be configured to redirect light from one side of the PIC 200 to another side of the PIC 200. The optical signal 402 from a first waveguide 430 may reach the first mirror 404 from a side of the PIC towards a first surface 410. The optical signal 402 may be reflected by first mirror 404 towards the second mirror 406. The second mirror 406 reflects the optical signal 402 to propagate along the side towards a second surface 412 (e.g., via a second waveguide 440 disposed along the second surface 412). A microlens array (e.g., microlens array 226) may be disposed on the second surface 412. Thus, the optical signal propagating along the second surface 412 may be directed to a microlens 214 of the microlens array 226. In some aspects, an optical via 400 may be implemented for each waveguide 430, 440 to propagate an optical signal to respective microlens 214. As shown, the optical via 400 may propagate optical signaling to/from the microlens array 226 and optical circuitry 450, which may be implemented on the first surface 410. While the optical via 400 is implemented with mirrors 404, 406 for redirecting an optical signal, any optical redirection element (e.g., mirror, micromirror, or grating) may be used.

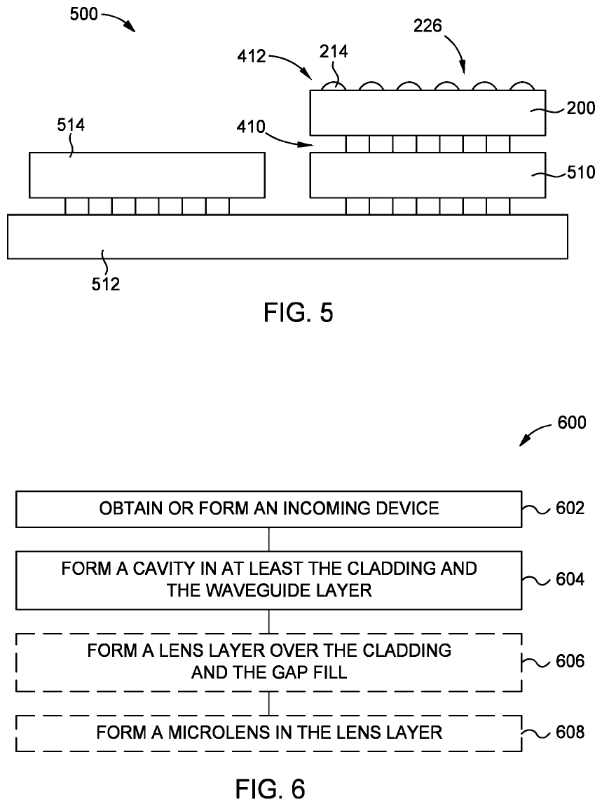

FIG. 5 illustrates an example electronic and optical device 500 including the PIC 200. The PIC 200 may be implemented with optical vias 400 to communicate optical signaling from one side of the PIC 200 to another side of the PIC 200. The optical signaling may be provided to a microlens array 226 implemented on the second surface 412. As shown, the microlens array 226 may be implemented on the second surface 412 facing upwards, allowing first surface 410 to be electrically coupled (e.g., via electrical connection elements) to an electrical IC (EIC) 510, as shown. As shown, the EIC 510 may be electrically coupled to an interposer 512 on which a graphical processing unit (GPU) 514 may be disposed.

As described, the second surface 412 of the PIC 200 may have the fiber I/O array while the first surface 410 has an electronic microbump. After flipping the chip, the electric signal is provided from an EIC 510 through the electronic microbump while the optical signal is going in and out through the fiber I/O array at the second surface 412 of the PIC 200. As described herein, a number of holes (e.g., openings) are created in a substrate 202 along the thickness directions. Both ends of the hole may have an optical structure (e.g., mirrors, micromirrors, gratings) that redirects the light passing along the surface (e.g., horizontal direction) to the vertical direction so that the light coming from one side of the PIC 200 is directed to the other side of the PIC 200. Thus, a fiber I/O array may be disposed one side (e.g., second surface 412) and electrical I/Os may be disposed on the first surface 410. The PIC 200 may be flipped so that the electrical I/O side is facing and connected to another electrical chip, as described. The fiber I/O side may be facing up and connected to an array of optical fibers, in some aspects.

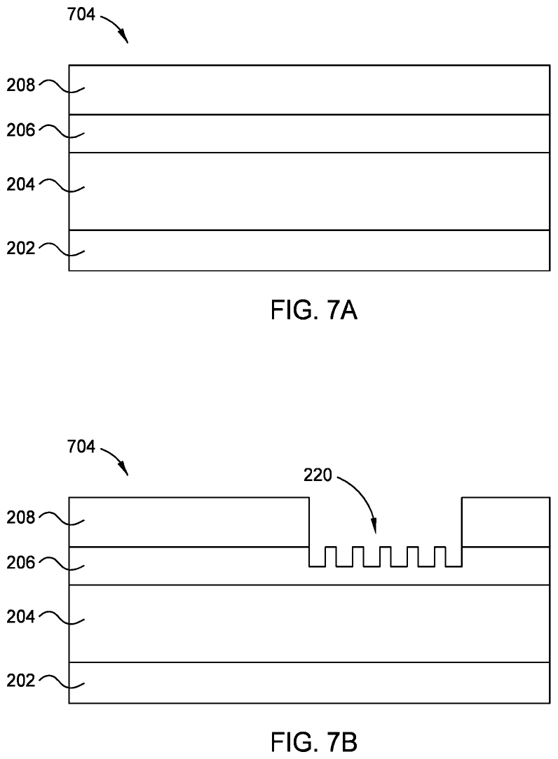

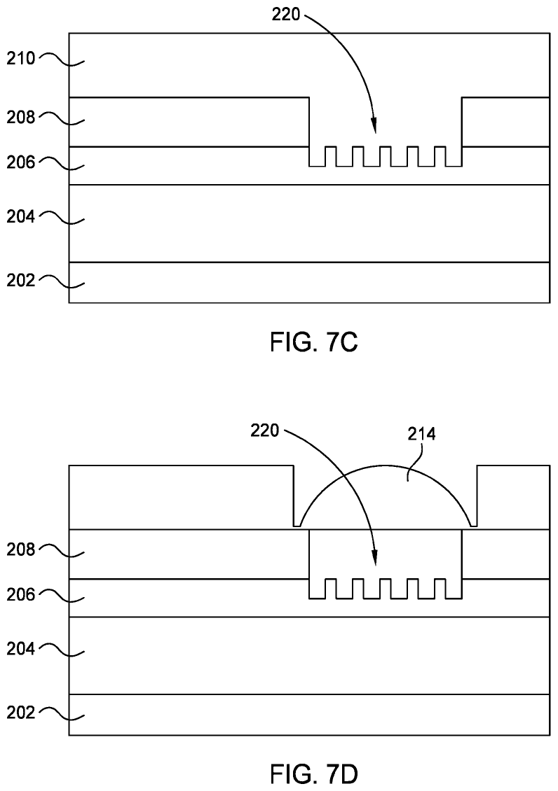

FIG. 6 illustrates a flow diagram of a method 600 of forming a photonic device. FIG. 7 illustrates schematic, cross-sectional view of the photonic device during the method 600. The photonic device (e.g., the SiPho chip 108) includes a photonic assembly (e.g., the optical configuration 200B of the PIC 200). The method 600 may be performed, for example, by a fabrication facility or system.

At operation 602, shown in FIG. 7A, an incoming device 704 may be obtained or formed. The incoming device may include a substrate 202, a buried oxide (BOX) layer 204, a waveguide layer 206, and a cladding 208. The BOX layer 204 may be disposed over the substrate 202. The waveguide layer 206 may be disposed over the BOX layer 204. The cladding 208 may be disposed over the waveguide layer 206. The waveguide layer may include a waveguide layer 206.

At operation 604, as shown in FIG. 7B, a device 220 may be formed through (or in) at least the cladding 208 and the waveguide layer 206. The device 220 may be formed using any suitable etching processing, such as a wet etching process and/or a dry etching processor. The etching processing may be performed to selectively remove a portion of the cladding 208 and the waveguide layer 206. The etching depth may be 100 nm to 1000 μm, and the etching diameter may be 100 nm to 1000 μm, for example.

Optionally, at operation 606, as shown in FIG. 7C, a lens layer 210 may be formed over the cladding 208. For example, the lens layer 210 may be formed over the cladding 208 via a deposition process. The lens layer 210 may be deposited via chemical vapor deposition (CVD), a physical vapor deposition (PVD), and/or atomic layer deposition (ALD), for example. The lens layer 210 may include, for example, aSi, SiO, SiN, TiO, TaO, NbO, AlO, CrO, MgO, or any combination thereof. The lens layer 210 may have a thickness of 100 nm to 1000 μm, for example.

Optionally, at operation 608 as shown in FIG. 7D, a microlens 214 may be formed in the lens layer 210. For example, the lens layer 210 may be patterned to form the microlens 214. The microlens 214 may be disposed over the cladding 208. The lens layer 210 may be patterned via photolithography, nanoimprint lithography (NIL), gray-tone lithography, e-beam lithography, etching, focused ion beam milling, ion milling, or any combination thereof. In some cases, the microlens 214 includes a Fresnel lens, a flat optic, or a metasurface. The microlens 214 is aligned with the device 220. The microlens may include an organic liquid, and has a diameter from about 100 nm to about 1000 μm. In some embodiments, operation 608 is repeated to form multiple microlenses 214. For example, a second lens layer is disposed over the lens layer 210 and a second lens is patterned in the second lens layer. The second lens layer is aligned with the device 220.

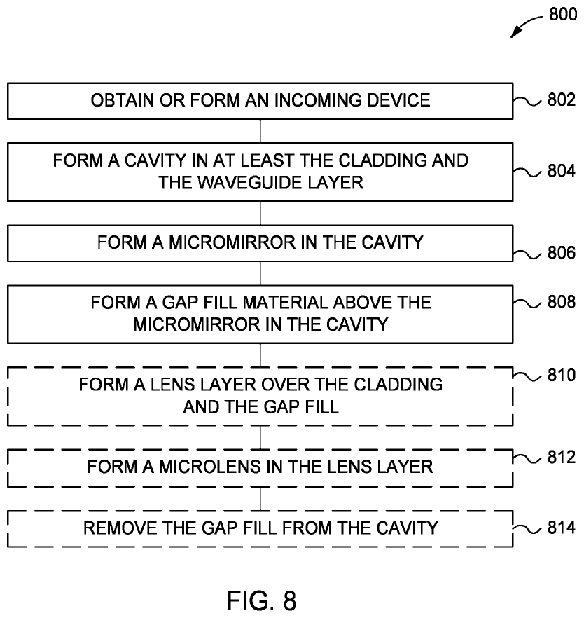

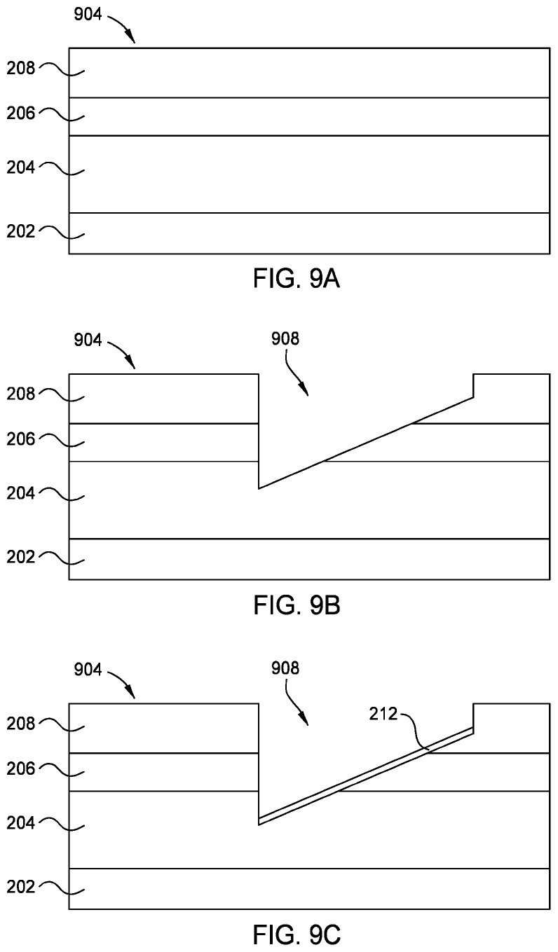

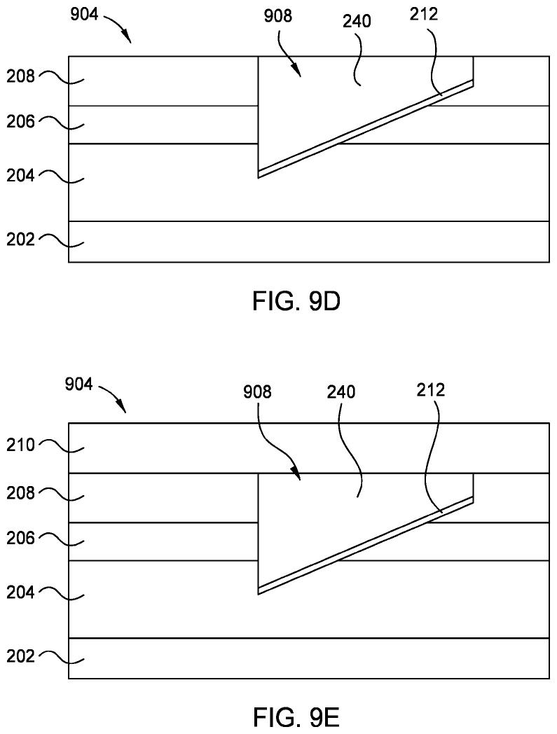

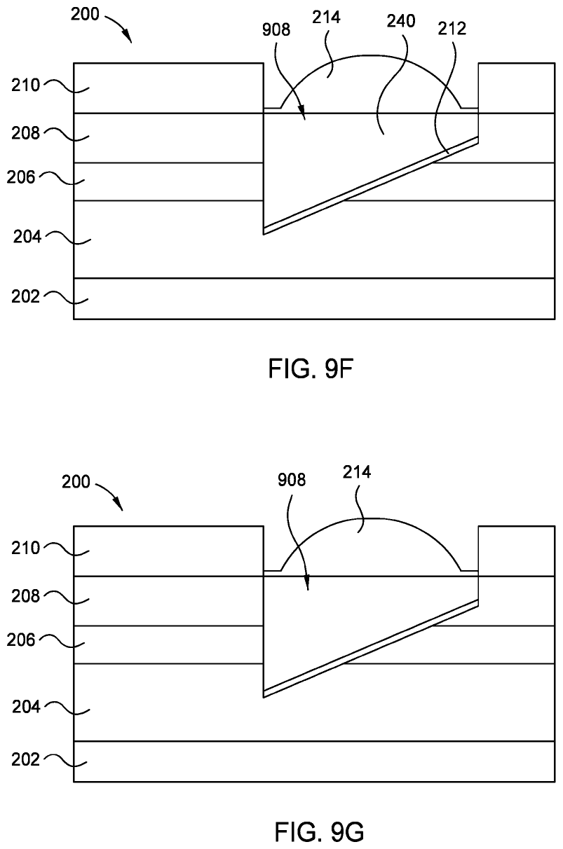

FIG. 8 illustrates a flow diagram of a method 800 of forming a photonic device. FIG. 9 illustrates schematic, cross-sectional view of the photonic device during the method 800. The photonic device (e.g., the SiPho chip 108) includes a photonic assembly (e.g., the optical configuration 200C of the PIC 200). The method 800 may be performed, for example, by a fabrication facility or system.

At operation 802, shown in FIG. 9A, an incoming device 904 may be obtained or formed. The incoming device may include a substrate 202, a buried oxide (BOX) layer 204, a waveguide layer 206, and a cladding 208. The BOX layer 204 may be disposed over the substrate 202. The waveguide layer 206 may be disposed over the BOX layer 204. The cladding 208 may be disposed over the waveguide layer 206. The waveguide layer may include a waveguide layer 206.

At operation 804, as shown in FIG. 9B, a cavity 908 may be formed through (or in) at least the cladding 208 and the waveguide layer 206. In some cases, the cavity 908 may be formed in at least a portion of the BOX layer 204. In other embodiments, the cavity 908 may intersect the BOX layer 204, the waveguide layer 206, and/or the cladding 208. The cavity 908 may be formed using any suitable etching processing, such as a wet etching process and/or a dry etching processor. The cavity 908 may be formed to have a slanted surface, for example, having an angle of 0 degrees to 90 degrees. The etching processing may be performed to selectively remove a portion of the cladding 208, the waveguide layer 206, and/or the BOX layer 204. The etching depth may be 100 nm to 1000 μm, and the etching diameter may be 100 nm to 1000 μm, for example.

At operation 806, as shown in FIG. 9C, a micromirror 212 may be formed in the cavity 908. For example, the micromirror 212 may be formed via a deposition of a reflective metal or metal alloy. The micromirror 212 may include, for example, aluminum (Al), silver (Ag), copper (Cu), gold (Au), chromium (Cr), titanium (Ti), or any combination thereof. The micromirror 212 may be arranged in at least a portion of the waveguide layer 206. In some cases, the micromirror may be arranged in the cavity 908 that intersects the BOX layer 204, the waveguide layer 206, and/or the cladding 208. In some cases, a coating may be applied to the sidewall of the cavity 908 and/or the micromirror 212. For example, an anti-reflective coating may be formed on the sidewall of the cavity 908. In certain cases, a protective coasting may be formed on the micromirror 212, such as oxidation protection. The coating may include a dielectric film including, for example, SiO, SiN, TiO, NbO, TaO, AlO, or any combination thereof.

At operation 808, as shown in FIG. 9D, a gap fill 240 may be formed over the micromirror 212 in the cavity 908. The gap fill 240 may be formed in the cavity 908 via a deposition process. A planarization process (e.g., a chemical mechanical planarization (CMP) process) may be performed to smooth the upper surface of the gap fill 240. The gap fill 240 may include any dielectric film, including, for example, silicon oxide (SiOx), silicon nitride (SiNx), titanium oxide (TiOx), or a combination thereof.

Optionally, at operation 810, as shown in FIG. 9E, a lens layer 210 may be formed over the cladding 208 and the gap fill 240. For example, the lens layer 210 may be formed over the cladding 208 and the gap fill 240 via a deposition process. The lens layer 210 may be deposited via chemical vapor deposition (CVD), a physical vapor deposition (PVD), and/or atomic layer deposition (ALD), for example. The lens layer 210 may include, for example, aSi, SiO, SiN, TiO, TaO, NbO, AlO, CrO, MgO, or any combination thereof. The lens layer 210 may have a thickness of 100 nm to 1000 μm, for example.

Optionally, at operation 812 as shown in FIG. 9F, a microlens 214 may be formed in the lens layer 210. For example, the lens layer 210 may be patterned to form the microlens 214. The microlens 214 may be disposed over the cladding 208, where the microlens is aligned with the micromirror 212. The lens layer 210 may be patterned via photolithography, nanoimprint lithography (NIL), gray-tone lithography, e-beam lithography, etching, focused ion beam milling, ion milling, or any combination thereof. It will be appreciated that any suitable microlens may be disposed over the micromirror 212, such as a patterned microlens as described herein with respect to operations 810, 812. In some cases, a Fresnel lens, a flat optic, or a metasurface may be disposed over the micromirror 212. Optionally, at operation 814, as shown in FIG. 9G, the gap fill 240 may be removed from the cavity 908.

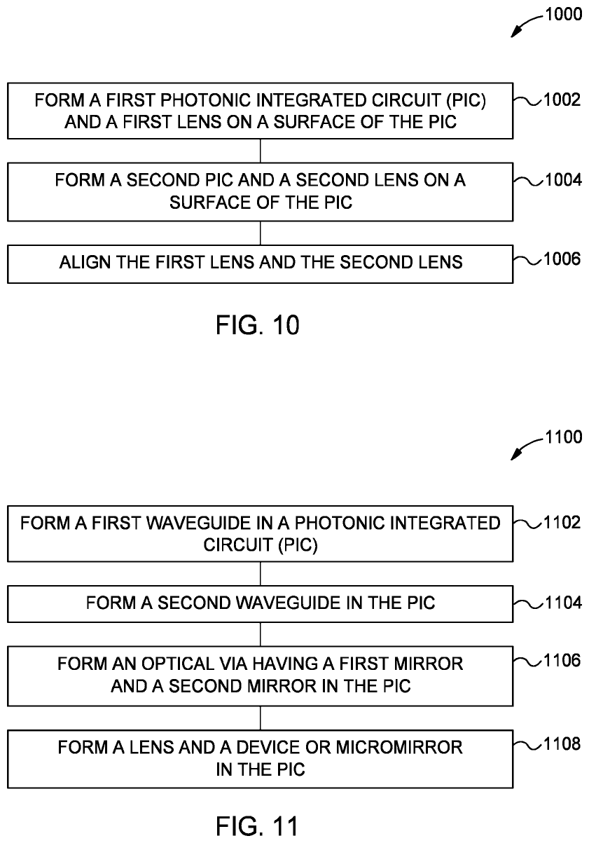

FIG. 10 illustrates a flow diagram of a method 1000 of forming a photonic system 300. The method 1000 may be performed, for example, by a fabrication facility. At operation 1002, the fabrication facility may form a first PIC (e.g., first PIC 302), a first lens (e.g., first microlens 306) being disposed on a surface of the first PIC. The first PIC 302 may be formed using method 600 or method 800. At operation 1004, the fabrication facility may form a second PIC (e.g., second PIC 304), a second lens (e.g., first microlens 310) being disposed on a surface of the second PIC 304. The second PIC 304 may be formed using method 600 or method 800. At operation 1006, the fabrication facility may align the first microlens 306 with the first microlens 310 such that an optical beam is communicated between the first microlens 306 and the first microlens 310. In some aspects, the first microlens 306 is aligned with the first microlens 310 such that the surface of the first PIC 302 is in a facing relationship with the surface of the second PIC 304. In some aspects, the first microlens 306 is part of a first array (e.g., corresponding to microlens array 226) of lenses, and the first microlens 310 is part of a second array of lenses. The fabrication facility may align the first array of lenses with the second array of lenses, respectively. In some aspects, forming the first PIC 302 may include: forming a waveguide (e.g., waveguide layer 206) and forming a device 220 (e.g., grating) or mirror (e.g., micromirror 212) to change a direction of the optical signal from the waveguide to the first microlens 306.

FIG. 11 illustrates a flow diagram of a method 1100 of forming an electronic and optical device 500 including the PIC 200. The method 1100 may be performed, for example, by a fabrication facility. At operation 1102, the fabrication facility may form a first waveguide (e.g., first waveguide 430) in the PIC 200. At operation 1104, the fabrication facility may form a second waveguide (e.g., second waveguide 440) in the PIC 200. At operation 1106, the fabrication facility may form an optical via (e.g., optical via 400) having a first optical redirection element (e.g., first mirror 404) and a second optical redirection element (e.g., second mirror 406) in the PIC 200. The first mirror 404 element reflects an optical signal (e.g., optical signal 402) from the first waveguide 430 to the second mirror 406. The second mirror 406 reflects the optical signal from the first mirror 404 to the second waveguide 440.

Optionally, at operation 1108, the fabrication facility may form a lens (e.g., microlens 214) and form a device 220 or a micromirror 212 in the PIC to change a direction of the optical signal from the second mirror 406 towards the microlens 214. In some aspects, the microlens 214 may be formed on a second surface (e.g., second surface 412) on a first surface 410 of the PIC. The second waveguide 440 may be formed along the second surface 412, and the first waveguide 430 may be formed along a first surface 410 of the PIC opposite to the second surface 412. In some aspects, the fabrication facility may form electrical connection elements (e.g., for coupling to EIC 510) coupled to a first surface 410 of the PIC. In some aspects, the fabrication facility may form optical circuitry on the second surface 412 of the PIC and coupled to the first waveguide 430.

While the foregoing is directed to aspects of the present disclosure, other and further aspects of the disclosure may be devised without departing from the basic scope thereof, and the scope thereof is determined by the claims that follow.

What is claimed is:

1. A photonic integrated circuit, comprising:
a substrate;
a buried oxide (BOX) layer disposed over the substrate;
a waveguide layer disposed over the BOX layer, the waveguide layer comprising a waveguide;
a micromirror arranged in at least a portion of the waveguide layer;
a cladding disposed over the waveguide layer; and
a lens layer disposed over the cladding, the lens layer having a microlens aligned with the micromirror.

2. The photonic integrated circuit of claim 1, wherein:
the micromirror comprises aluminum (Al), silver (Ag), copper (Cu), gold (Au), chromium (Cr), titanium (Ti), or any combination thereof; and
an optical reflection path associated with the micromirror intersects at least a portion of the microlens.

3. The photonic integrated circuit of claim 1, further comprising a gap fill material disposed between the micromirror and the microlens.

4. The photonic integrated circuit of claim 1, wherein the lens layer comprises amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), or a combination thereof.

5. The photonic integrated circuit of claim 1, wherein the microlens comprises a microlens array, a Fresnel lens, a flat optic, or a combination thereof.

6. The photonic integrated circuit of claim 1, wherein the micromirror may be coated with a protective coating comprising SiO, SiN, TiO, NbO, TaO, AlO, or any combination thereof.

7. The photonic integrated circuit of claim 1, wherein the cladding comprises amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), or any combination thereof.

8. A photonic integrated circuit, comprising:
a first waveguide;
a second waveguide; and
an optical via having a first optical redirection element and a second optical redirection element, wherein the first optical redirection element is configured to reflect an optical signal from the first waveguide to the second optical redirection element, and wherein the second optical redirection element is configured to reflect the optical signal from the first optical redirection element to the second waveguide.

9. The photonic integrated circuit of claim 8, wherein each of the first optical redirection element or the second optical redirection element includes a mirror or a grating.

10. The photonic integrated circuit of claim 8, further comprising:
a lens; and
a third optical redirection element configured to change a direction of the optical signal from the second optical redirection element towards the lens.

11. The photonic integrated circuit of claim 10, wherein:
the lens is disposed on a first surface on a first surface of the photonic integrated circuit, wherein the second waveguide is disposed along the first surface, and wherein the first waveguide is disposed along a second surface of the photonic integrated circuit opposite to the first surface.

12. The photonic integrated circuit of claim 11, further comprising electrical connection elements coupled to a second surface on the second surface of the photonic integrated circuit.

13. A photonic system, comprising:
a first photonic integrated circuit (PIC), a first lens being disposed on a surface of the first PIC; and
a second PIC, a second lens being disposed on a surface of the second PIC, wherein the first lens is aligned with the second lens such that an optical signal is configured to be communicated between the first lens and the second lens.

14. The photonic system of claim 13, wherein the surface of the first PIC is in a facing relationship with the surface of the second PIC.

15. The photonic system of claim 13, wherein:
a first array of lenses comprises the first lens; and
a second array of lenses comprises the second lens, the first array of lenses being aligned with the second array of lenses.

16. The photonic system of claim 13, the first PIC comprises:
a waveguide; and
a grating or mirror configured to change a direction of the optical signal from the waveguide to the first lens.

17. A photonic system, comprising:
a substrate;
a buried oxide (BOX) layer disposed over the substrate;
a device layer disposed over the BOX layer, the device layer having a device;
a cladding disposed over the device layer; and
a lens layer disposed over the cladding, the lens layer having a microlens aligned with the device.

18. The system of claim 17, wherein the device is a grating coupling, waveguide, mode-volume converter, a laser, a LED, VECEL, DNA cell, or on-chip biological device.

19. The system of claim 17, wherein the device layer is a waveguide and the device is a grating.

20. The system of claim 17, wherein the lens layer comprises amorphous silicon (aSi), silicon oxide (SiOx), silicon nitride (SiNx), titanium oxide (TiOx), tantalum oxide (TaOx), niobium oxide (NbOx), aluminum oxide (AlOx), chromium oxide (CrOx), magnesium oxide (MgOx), or combinations thereof.
